(19) United States
(12) Patent Application Publication
(10) Pub. No.: US 2009/0025400 A1
(43) Pub. Date: Jan. 29, 2009

(54) Device and Method for Protecting a Cryogenic Tank and Tank Comprising Such a Device

(75) Inventors: Herve BARTHELEMY, Montevrain (FR); Laurent Allidieres, Saint Martin D'Uriage (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/122,361

(22) Filed: May 16, 2008

Related U.S. Application Data
(63) Continuation-in-part of application No. PCT/FR2006/051023, filed on Oct. 27, 2006.

(30) Foreign Application Priority Data
Nov. 18, 2005 (FR) 05-53498

(51) Int. Cl. F17C 13/02; F17C 1/00

(52) U.S. Cl. 62/49.1; 220/560.1

(57) ABSTRACT

Method for protecting a cryogenic tank, the tank comprising two concentric casings between them delimiting an inter-wall space in which a so-called low pressure obtains, the method involving: a step of detecting an impact on the tank and/or an increase in pressure within the inter-wall space, characterized in that it involves a step of generating a stream of inert gas within the inter-wall space only if an impact on the tank of a determined intensity and/or a determined increase in pressure at the inter-wall space is/are detected.

### CROSS-REFERENCE TO RELATED APPLICATIONS

This application is a Continuation-In-Part of International PCT Application PCT/FR2006/051023, filed Oct. 27, 2006.

### BACKGROUND

The present invention relates to a method of protecting a cryogenic tank, to a device for protecting a cryogenic tank and to a tank comprising such a device.

The invention relates more specifically to the protecting of a cryogenic tank comprising two concentric casings between them delimiting an inter-wall space in which a so-called low pressure obtains.

Cryogenic tanks are generally made up of two concentric metal casings separated from one another by an inter-wall void. The evacuated inter-wall space is designed to provide the internal tank that contains the cold cryogenic fluid with thermal insulation from the temperature outside the tank, which is hotter. The working pressure inside the inter-wall space is generally of the order of 10⁻⁵ mbar.

Insulation known as multi-layer insulation is generally installed in this inter-wall space in order to optimize the insulation, particularly with respect to radiation heat transfer. This multi-layer insulation conventionally comprises several interleaved layers made up of a succession of reflective and insulating materials.

In the case of cryogenic fluids the temperature of which is below the temperature at which air liquefies (particularly in the case of hydrogen and helium), liquefied air (a mixture containing approximately 50 wt % of liquid oxygen and 50% liquid nitrogen) may form on the cold wall of the inert tank if the inter-wall vacuum is destroyed. In the event of an impact or shock subsequent to this rupture, the multi-layer insulation may catch fire because it is in direct contact with an oxygen-enriched atmosphere. Such ignition may have a serious impact on the integrity of the tank.

Following a number of accidents, a European standard (EN1797) has laid down requirements associated with the use of the multi-layer insulation on cryogenic containers. That standard in particular specifies the compatibilities between the insulating layers and an oxygen-enriched atmosphere. The standard stipulates that the insulation must not catch fire in the event of an impact (impact energy equal to 100 joules) in a cryogenic liquid atmosphere made up of half nitrogen and half oxygen (these proportions being expressed as percentages by weight).

Insulations comprising reflective sheets of aluminized polymer materials (of the Mylar® type) cannot be used because the polymers involved are not compatible with oxygen because of the regulations that follow from the standard EN1797.

Acceptable multi-layer insulations are of the type comprising a layer of aluminum, for example measuring from 12 n to 15 μm and an interleaved layer of glass paper for example 89 μm thick. These multi-layer combinations are employed satisfactorily by industry to insulate large containers (typically containers with a capacity of several thousand liters of liquid hydrogen).

The on-board liquid hydrogen tanks used in automotive applications have smaller capacities (typically ranging between 60 and 200 liters). These tanks generally comprise numerous tank inlet and outlet pipes for, in particular: filling with liquid, tapping off liquid, tapping off gas, and inserting level gauges.

Each tapping into the tank creates a discontinuity in the insulated surface which detracts from the correct insulation of the tank. Specifically, in the case of insulation comprising conducting layers (for example of aluminum), if these layers come into contact with one another or with a tube they lose at least some of their heat shielding properties with respect to the radiation incident on the inert casing. These tanks are designed in such a way as to limit the number of such discontinuities and it is commonly accepted that just one discontinuity in the insulation that is not handled carefully during the manufacturing process will lead to thermal losses of the order of 0.5 watts, which represents approximately one third of the nominal thermal loss of the tank.

However much care is taken, it is therefore very difficult to insulate these tanks with a conductive/glass paper multilayer satisfactorily because the slightest negligence during the manufacturing process has a significant detrimental effect on the thermal performance of the tank.

It is an object of the present invention to alleviate all or some of the abovementioned disadvantages of the prior art.

### SUMMARY OF THE INVENTION

The invention includes both methods and apparatus to achieve the desired results, as described, but is not limited to the various embodiments disclosed.

To the aforementioned end, the method according to the invention, in other respects in accordance with the generic definition thereof given in the above preamble, is characterized in that it comprises:
a step of detecting an impact or shock with the tank and/or a variation in pressure inside the inter-wall space and, if an impact or shock of determined intensity with the tank and/or a determined variation in pressure at the inter-wall space is/are detected,
a step of generating a flow of inert gas inside the inter-wall space.

Another object of the invention is to provide a device for protecting a cryogenic tank.

According to one particular feature of the invention, the device for protecting a cryogenic tank comprises means of detecting an impact or shock and/or a pressure variation, inerting means capable of delivering a flow of inert gas, release means collaborating with the detection means and the inerting means to command the delivery of a flow of inert gas by the inerting means when the detection means detect an impact or shock of determined intensity and/or a determined variation in pressure.

According to one advantageous particular feature, the detection means are capable of detecting a thermal shock in order to command the delivery of a flow of inert gas by the inerting means in the event of a thermal shock of determined intensity.

Another object of the invention is to propose a cryogenic tank comprising a protection device such as this.

To this end, the cryogenic tank according to the invention, comprising two concentric casings these being respectively an inner casing and an outer casing, the inner casing being intended to contain a fluid or mixture of fluids, the two casings between them delimiting an inter-wall space in which a so-called low pressure obtains, is essentially characterized in that it comprises a protection device according to any one of the above features, the detection means being designed to detect an impact or shock on the tank and/or a variation in pressure inside the inter-wall space, the inerting means being capable of delivering a flow of inert gas inside the inter-wall space.

Furthermore, the invention may comprise one or more of the following features:
the inerting means comprise a reserve of pressurized inert gas,
the release means comprise a system of the rupturable or removable type capable of opening a passage between the inerting means and the inter-wall space,
the protection device comprises a box mounted on the outer casing and communicating with the inter-wall space, a rupturable barrier preventing a flow of inert gas between the inerting means and the inter-wall space, the release means comprising a striker subjected, on the one hand, to the pressure in the inter-wall space and, on the other hand, to the action of return means, the striker being capable of moving relative to the box between a position that is inactive with respect to the rupturable barrier and an active position that causes the rupturable barrier to rupture,
the tank comprises means forming a safety valve venting to the atmosphere and designed to dump to the atmosphere a fraction of the flow of inert gas delivered by the inerting means if a determined overpressure is reached,
the tank has a capacity of less than two thousand liters and preferably of less than 500 liters,
the inerting means comprise helium so as to allow any leak to be detected.

### BRIEF DESCRIPTION OF THE DRAWINGS

Other particulars and advantages will become apparent from reading the description that follows, which is given with reference to the Figures in which:

FIG. 1 is a schematic cross section of one exemplary embodiment of a tank according to the invention,

FIG. 2 is a schematic cross section view in of a detail of FIG. 1, illustrating a protection device according to one exemplary embodiment of the invention.

### DETAILED DESCRIPTION OF THE PREFERRED EMBODIMENTS

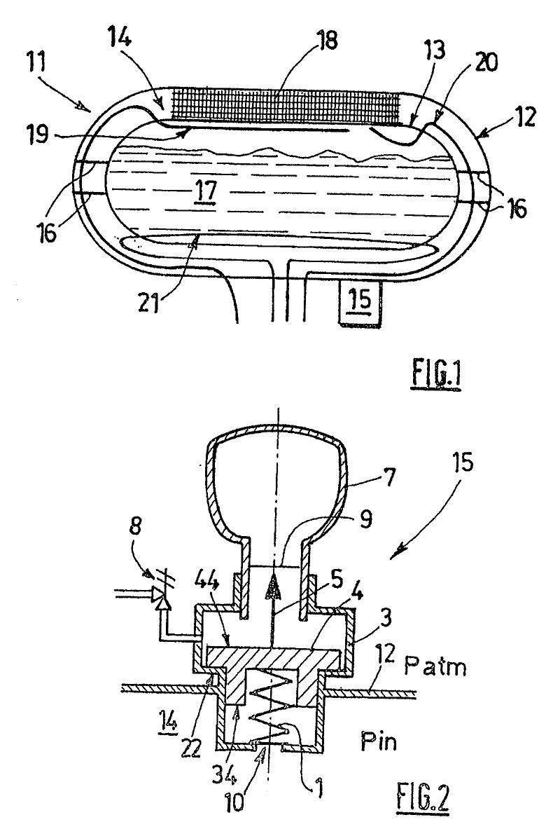

The cryogenic tank 11 depicted in FIG. 1 comprises an inner first casing 13 intended to contain a fluid or a mixture of fluids 17, for example a mixture of liquid and gaseous hydrogen. The tank 11 comprises an outer second casing 12. The outer casing 12 is arranged concentrically around the inner casing 13. The two casings 13, 12 between them delimiting the inter-wall space 14 in which a so-called low pressure (a pressure for example of below 10⁻³ mbar) obtains.

Conventionally, the inter-wall space 14 contains means 16 serving to support the inner tank 13.

The inter-wall space 14 also contains insulating means 18, such as a conducting or non-conducting multilayer. For example, the insulating means 18 comprise a multilayer comprising a combination of aluminized polyethylene terephthalate and glass paper.

Conventionally, the tank 11 also comprises, opening into the inner casing 13: a filling tube 19, a tube 20 for tapping off gas and a tube 21 for heating the liquid 17 so as to maintain the pressure in the tank as gas is tapped off using the pipe 20.

According to one advantageous feature of the invention, the tank 11 comprises a protection device 15 allowing the inter-wall space 14 to be flushed with inert gas.

The protection device 15, depicted in greater detail in FIG. 2, comprises a box 3 or manifold mounted on the tank 11. The box 3 passes through the outer casing 12 of the tank 11 and communicates with the inter-wall space 14. A cylinder 7 of pressurized inert gas is mounted on the box 3, for example by screw-fastening, on the outside of the tank 11. The cylinder 7 of inert gas is closed by an impervious and rupturable membrane 6. For example, the cylinder 7 contains argon and/or helium and/or nitrogen or any other equivalent gas or mixture at a pressure preferably ranging between 5 and 700 bar. As a preference, a fraction of the pressurized fluid in the inert gas tank 7 (typically 2 to 4 vol %) is helium so that any leaking of the membrane 6 can be detected, for example using spectrometry, during the production cycle used to produce the tank 7.

The end of the box 3 that projects into the inter-wall space 14 comprises an orifice 10 to allow the inside of the box 3 to communicate with the inter-wall space 14.

The box 3 contains a vacuum tight stopper 4 capable of moving relative to a seat 22 formed inside the box 3. A first face 34 of the stopper 4 is subjected to the depression (the low pressure Pin, for example lower than 10⁻² mbar) obtaining inside the inter-wall space 14, while a second, opposite, face 44 of the stopper 4 is subjected to the pressure outside the tank 11 (atmospheric pressure Patm).

The stopper 4 is forced off its seat 22 by a spring 1 (for example a compression spring). As a preference, the spring 1 exerts on the stopper 4 a force of a strength substantially equivalent to half the pressure difference across the stopper ((Patm−Pin)/2).

The seat 22 is rendered gastight by one or more O ring seals (not depicted) positioned in grooves on the cylindrical face of the stopper 4. The face 44 of the stopper 4 that is subjected to atmospheric pressure Patm comprises a needle 5 designed to be able to cooperate with the membrane 6.

As a preference, when the stopper 4 is off its seat 22, mechanical means (not depicted) prevent the stopper 4 from returning to its seat 22 (for example using mating shapes of the stopper 4 and of the seat 22).

If the vacuum within the inter-wall space 14 is ruptured, the force exerted by the depression Pin on the stopper 4 disappears and the force of the spring 1 becomes sufficient to push the stopper 4 of its seat 22. The end of the needle 5 then strikes and punctures the membrane 6, thus releasing the gas from the cylinder 7.

The pressurized gas from the cylinder then enters the inter-wall space 14 via the orifice 10.

Advantageously, the internal space of the box 3 may have a vent 8 to the outside via a safety valve that dumps excess pressure of inert gas. The valve 8 protects the system in the event that the membrane 6 leaks.

Of course, the invention is not restricted to the exemplary embodiment described hereinabove. Thus, as an alternative or in combination, the flushing of the inter-wall space 14 with inert gas can be triggered in the event of an impact or shock to the tank. Flushing may in particular be triggered automatically on the basis of the response of an impact or shock detector (particularly an accelerometer) sensitive to the stresses experienced by the tank 11. A system such as this may be analogous to the mechanically and/or pyrotechnically initiated devices used on airbag systems. It may also be a mechanical or magnetic means of causing translational movement of the stopper 4 or of subjecting the face 44 to a vacuum. For example, the system that triggers the inerting may just as easily be a thermal system using a eutectic metal alloy capable of making a hole in the membrane 6 if heated up, for example, in the event of a fire outside the system. The means of detecting an impact or shock to the system are then preferably capable of detecting a “thermal shock”.

It will therefore be readily understood that the invention, while being of a simple and inexpensive structure, provides effective protection to cryogenic tanks in the event of an accident. The invention makes it possible to prevent any risk of a build-up of oxygen concentration near the cold wall of the inner casing by flushing the inter-wall space with an excess of inert gas taken from a source 7.

The invention thus in particular makes it possible to use multilayer insulation comprising a reflective non-conducting layer (which is therefore made of a flammable material such as a polymer).

The inert gas forced into the inter-wall space 14 in the event of an impact or shock solidifies upon contact with the cold outer wall of the inner casing 13. This solidified inert gas therefore forms a solid layer which thermally and mechanically insulates and isolates this casing 13. The temperature of that part of the tank that is subjected to the air is therefore higher than the temperature at which the air liquefies.

The risk of oxygen enrichment of regions containing incompatible (flammable) materials can thus be avoided.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

We claim:

1. A method of protecting a cryogenic tank, the tank comprising concentrically disposed inner and outer casings between them delimiting an inter-wall space at low pressure, said method comprising the steps of:
detecting an impact or shock to the tank and/or an increase in pressure inside the inter-wall space;
generating a flow of inert gas inside the inter-wall space only if an impact or shock of determined intensity with the tank and/or a determined increase in pressure at the inter-wall space is/are detected.

2. A cryogenic tank comprising:
concentrically disposed inner and outer casings, said inner casing being adapted to contain a fluid or mixture of fluids, an inter-wall space defined between said two casings being at low pressure;
a protection device comprising a detecting element adapted to detect an impact or shock to said tank and/or a pressure variation in said inter-wall space;
an inerting element capable of delivering a flow of inert gas;
a release element collaborating with said detection element and said inerting element to command a delivery of a flow of inert gas by said inerting element, wherein said inerting element is designed to deliver a flow of inert gas inside said inter-wall space only in the event that an impact or shock to said tank and/or a pressure variation of determined intensity in said inter-wall space is detected by said deteting element.

3. The tank as claimed in claim 2, wherein said detection element is capable of detecting a thermal shock in order to command the delivery of a flow of inert gas by said inerting element in the event of a thermal shock of determined intensity.

4. The tank as claimed in claim 2, wherein said inerting element comprises a reserve of pressurized inert gas.

5. The tank as claimed in claim 2, wherein said release element comprises a rupturable or removable element capable of opening a passage between said inerting element and said inter-wall space.

6. The tank as claimed in claim 2, wherein said protection device comprises:
a box mounted on said outer casing that communicates with said inter-wall space;
a rupturable barrier preventing a flow of inert gas between said inerting element and said inter-wall space, said release element comprising a striker subjected on one hand to the pressure in said inter-wall space and on the other hand to the action of a return element, said striker being capable of moving relative to said box between a position that is inactive with respect to said rupturable barrier and an active position that causes said rupturable barrier to rupture.

7. The tank as claimed in claim 2, further comprising a safety valve venting to the atmosphere and designed to dump to the atmosphere a fraction of the flow of inert gas delivered by said inerting means if a determined overpressure is reached.

8. The tank as claimed in claim 2, wherein said tank has a capacity of less than two thousand liters.

9. The tank as claimed in claim 2, wherein said release element and/or said detection element are dimensioned in such a way as to command the delivery of a flow of inert gas when said inter-wall space experiences a pressure increase of the order of half the pressure difference between a pressure (Patm) outside said tank and a pressure (Pin) inside said inter-wall space.

10. The tank as claimed in claim 2, wherein said inerting element comprises helium so as to allow any leak to be detected.

11. The tank as claimed in claim 2, wherein said tank has a capacity of less than 500 liters.

12. The tank as claimed in claim 6, wherein said detection element is capable of detecting a thermal shock in order to command the delivery of a flow of inert gas by said inerting element in the event of a thermal shock of determined intensity.

13. The tank as claimed in claim 6, further comprising a safety valve venting to the atmosphere and designed to dump to the atmosphere a fraction of the flow of inert gas delivered by said inerting means if a determined overpressure is reached.

14. The tank as claimed in claim 6, wherein said release element and/or said detection element are dimensioned in such a way as to command the delivery of a flow of inert gas when said inter-wall space experiences a pressure increase of the order of half the pressure difference between a pressure (Patm) outside said tank and a pressure (Pin) inside said inter-wall space.

15. The tank as claimed in claim 6, wherein said inerting element comprises helium so as to allow any leak to be detected.

16. The tank as claimed in claim 9, wherein said detection element is capable of detecting a thermal shock in order to command the delivery of a flow of inert gas by said inerting element in the event of a thermal shock of determined intensity.

17. The tank as claimed in claim 9, further comprising a safety valve venting to the atmosphere and designed to dump to the atmosphere a fraction of the flow of inert gas delivered by said inerting means if a determined overpressure is reached.

18. The tank as claimed in claim 9, wherein said release element and/or said detection element are dimensioned in such a way as to command the delivery of a flow of inert gas when said inter-wall space experiences a pressure increase of the order of half the pressure difference between a pressure (Patm) outside said tank and a pressure (Pin) inside said inter-wall space.

19. The tank as claimed in claim 9, wherein said inerting element comprises helium so as to allow any leak to be detected.

20. The tank as claimed in claim 6, further comprising a safety valve venting to the atmosphere and designed to dump to the atmosphere a fraction of the flow of inert gas delivered by said inerting means if a determined overpressure is reached, wherein:
said inerting element comprises a reserve of pressurized inert gas;
said tank has a capacity of less than two thousand liters;
said release element and/or said detection element are dimensioned in such a way as to command the delivery of a flow of inert gas when said inter-wall space experiences a pressure increase of the order of half the pressure difference between a pressure (Patm) outside said tank and a pressure (Pin) inside said inter-wall space; and
said inerting element comprises helium so as to allow any leak to be detected.
